(19) United States
(12) Patent Application Publication
(10) Pub. No.: US 2009/0058851 A1
(43) Pub. Date: Mar. 5, 2009

(54) METHOD FOR DRAWING GEOMETRIC SHAPES

(75) Inventors: Michal PIOTROWSKI, Wroclaw (PL); Mateusz HOBGARSKI, Jelenia Gora (PL)

Correspondence Address: MATTHIAS SCHOLL, 14781 MEMORIAL DRIVE, SUITE 1319, HOUSTON, TX, 77079, US

(73) Assignee: Osmosys S.A., Chambesy (CH)

(21) Appl. No.: 12/205,300

(22) Filed: Sep. 5, 2008

(30) Foreign Application Priority Data
Sep. 5, 2007 (EP) 07017373
Oct. 30, 2007 (EP) 07021139

(51) Int. Cl. G06T 15/00

(52) U.S. Cl. 345/419

(57) ABSTRACT

A method for drawing geometric shapes comprises the steps of obtaining a request to draw at least two geometric shapes, each having assigned a depth coordinate and at least one having the depth coordinate variable across its surface, dividing the geometric shapes into rectangles such that each rectangle has a constant depth coordinate, sorting the rectangles according to the depth coordinate value and drawing the rectangles in the sorted order so as to form an output image.

### CROSS-REFERENCE TO RELATED APPLICATIONS

This application claims priority to the European Patent Application No. EP07017373 filed on Sep. 5, 2007 and the European Patent Application No. EP07021139 filed on Oct. 30, 2007, the contents of which are incorporated herein by reference.

### BACKGROUND OF THE INVENTION

1. Field of the Invention

Technical concept presented herein relates to graphics processing systems, and more particularly, to graphics processing systems performing rotation of graphical images around X or Y axis and their later displaying including intersection of at least two images.

2. Brief Description of the Background of the Invention Including Prior Art

Rotations of images in three-dimensional space are well known in computer graphics. Nevertheless performance requirements are significant in such cases, therefore three-dimensional graphics is not available or available only to some extent in devices that have limited processing resources. Such devices are personal digital assistants, cellular telephones, receivers and decoders of digital television or the like.

Hence, there exists a problem of how to decrease performance requirements without compromising users experience while looking at video or graphical data output by the aforementioned devices.

### SUMMARY OF THE INVENTION

### Purposes of the Invention

It is an object of the present invention to provide a graphics processing method for drawing intersected rotated images that has low computing speed requirements and that will not lead to noticeable quality decrease.

This and other objects and advantages of the present invention will become apparent from the detailed description, which follows.

### Brief Description of the Invention

Owing to the use of splitting geometric shapes into rectangles and computation of a single depth coordinate for each rectangle, graphical systems performance can be increased due to lower resources allocation for drawing intersected geometric shapes. According to the present invention, a method for drawing geometric shapes comprises steps of

obtaining a request to draw at least two geometric shapes, each having assigned a depth coordinate and at least one having a depth coordinate variable across its surface;

dividing the geometric shapes into rectangles having a depth coordinate of constant value;

sorting the rectangles according to the depth coordinate of constant value; and

drawing the rectangles in a sorted order to form an output image.

Preferably, by the drawing the rectangles, for each rectangle, a corresponding part of a texture image is found taking perspective correction into account, which is copied with scaling in order to fit it into a rectangle being drew.

It is of special advantage that the sorting the rectangles is performed by putting to a beginning of sorted queue the rectangles with the depth coordinate further from an observer.

Preferably, the dividing the geometric shapes into rectangles comprises steps of defining a two dimensional outline of a rotated source geometric shape by performing its perspective projection onto a two dimensional plane and splitting the two dimensional outline, into intermediate rectangles, in places where pixel of either of the lines, non-parallel to the axis of rotation, of the two dimensional outline changes coordinates wherein in case of a rotation around the Y-axis, pixel's Y-coordinate value changes by n counted from a Y-coordinate value of a previous split point or a start point of a line non-parallel to the rotation axis of the two dimensional outline and wherein in case of a rotation around the X-axis, pixel's X-coordinate value changes by n counted from an X-coordinate value of a previous split point or a start point of a line non-parallel to the rotation axis of the two dimensional outline.

The lines, non-parallel to the axis of rotation, of the two dimensional outline can be calculated using Bresenham algorithm.

The value of the n parameter can be 1 or −1.

Preferably, at least one of the intermediate rectangles has four equal sides.

Preferably, all depth coordinates of the Z axis of the source geometric shape have equal value.

The idea of the invention is also a computer program comprising program code means for performing all the steps of the above-described method, when the program is run on a computer as well as a computer readable medium having computer-executable instructions performing all the steps of the above-described computer-implemented method.

### BRIEF DESCRIPTION OF THE DRAWINGS

This and other objects as well as advantageous features of the technical concept presented herein are accomplished in accordance with the principles of the presented technical concept by providing an improved method for drawing intersected rotated images. Further details and features of the system and method, its nature and various advantages will become more apparent from the accompanying drawing and the following detailed description of the preferred embodiments shown in a drawing, in which:

FIGS. 1A to 1D show an example of rotation around the X axis;

FIGS. 2A to 2D present an example of rotation around the Y axis;

FIGS. 3A to 3C depict an example of mapping between a source geometric shape, having a texture mapped thereto, and a two-dimensional outline;

FIG. 4 shows a block diagram illustrating steps of rotation method;

FIG. 5 shows a block diagram presenting steps of generating intersected geometric shapes;

FIG. 6 shows an example of intersected geometric shapes; and

FIG. 7 is an example of creation of intersected geometric shapes.

### DESCRIPTION OF INVENTION AND PREFERRED EMBODIMENT

The embodiments presented in the drawings are intended only for illustrative purpose and do not limit the scope of the present invention, as defined by the accompanying claims.

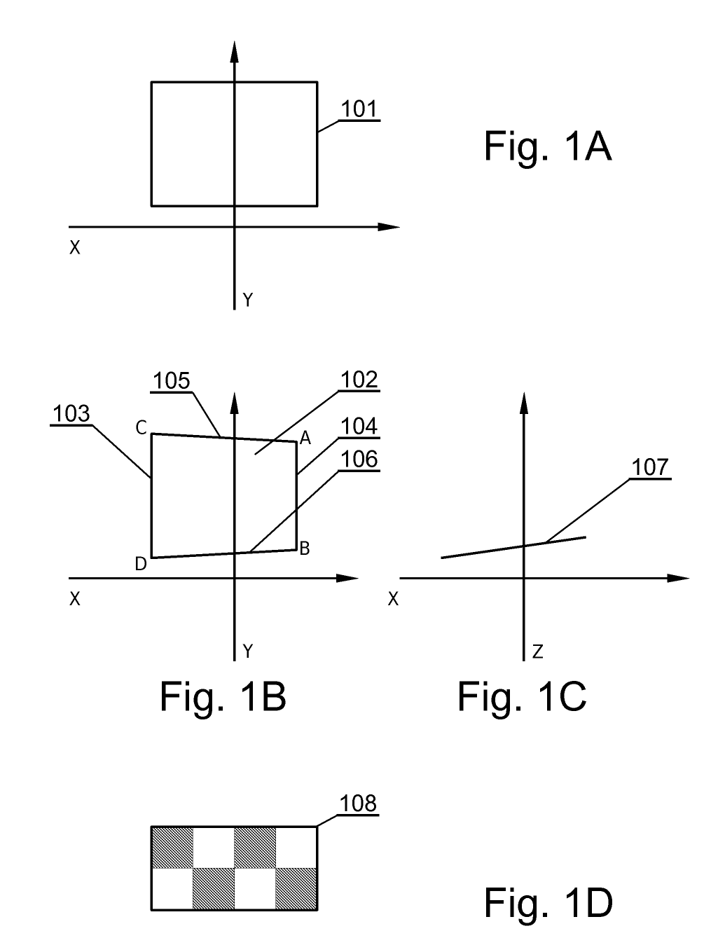

FIG. 1A presents a geometric shape having a form of a square 101 drawn on a two-dimensional X-Y plane. The four corners of the geometric shape have four pairs of corresponding X, Y coordinates. In such alignment the depth coordinate is constant for all pixels of the geometric shape 101.

When there is a need to rotate the geometric shape 101 around to Y axis, the depth coordinate becomes variable as presented in FIGS. 1B and 1C. The geometric shape 102, 107 is the geometric shape 101 rotated around the Y axis. Due to rotation, the geometric shape 102 is three-dimensional as presented with respect to the depth axis Z. As can bee seen, when such rotated geometric shape 102, or its outline, is projected onto a two dimensional X-Y plane its outline consists of two lines 103 and 104 that are parallel to the axis of rotation, which is Y in this example, and two angled lines 105, 106 positioned at an angle to the parallel lines 103, 104. The corners of the geometric shape 102 have been marked A-D respectively.

The geometric shape 101 has an assigned texture, which is shown in FIG. 1D. The texture 108 is to be mapped onto the geometric shape 101 and the geometric shape 102, which is the geometric shape 101 rotated in a three dimensional space.

An exemplary method for performing the projection onto a two dimensional X-Y plane can be a method defined by OpenGL Specification version 1.3, chapter 2.10—“Coordinate Transformations”.

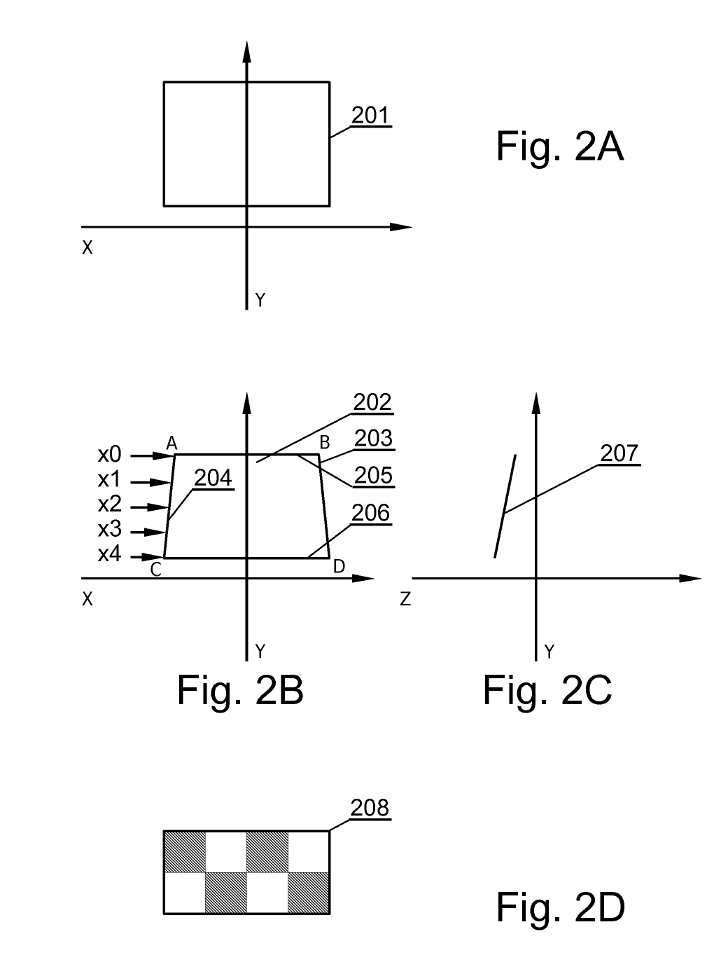

FIG. 2A presents a geometric shape having a form of a square 201 drawn on a two-dimensional X-Y plane. The four corners of the geometric shape have four pairs of corresponding X, Y coordinates. Similarly to FIG. 1A, in such alignment the depth coordinate is constant for all pixels of the image 201.

When there is a need to rotate the geometric shape 201 around the X axis, the depth coordinate becomes variable as presented in FIGS. 2B and 2C with respect to the Z coordinate. The geometric shape 202, 207 is the geometric shape 201 rotated around the X axis. As can bee seen, when such rotated geometric shape 202, or its outline, is projected onto a two dimensional X-Y plane it consists of two lines 205 and 206 that are parallel to the axis of rotation, which is X in this example, and two angled lines 203, 204 positioned at an angle to the parallel lines 205, 206. The corners of the geometric shape 202 have been marked A-D respectively. Point A of line AC has an X coordinate, which amounts x0. Because the line AC 204 is an angled line, its pixels coordinates going towards the X axis, which is a rotation axis, change their coordinates by, for example, one pixel to x1, x2, x3 until x4, which is an X coordinate of point C. It is possible that a number of pixels between X0 and x1, x1 and x2, . . . , x(n-1) and x(n) will be predetermined and greater than 1.

The geometric shape 201 has an assigned texture, which is shown in FIG. 2D. The texture 208 is to be mapped onto the geometric shape 201 and the shape 202, which is 201 rotated in a three dimensional space.

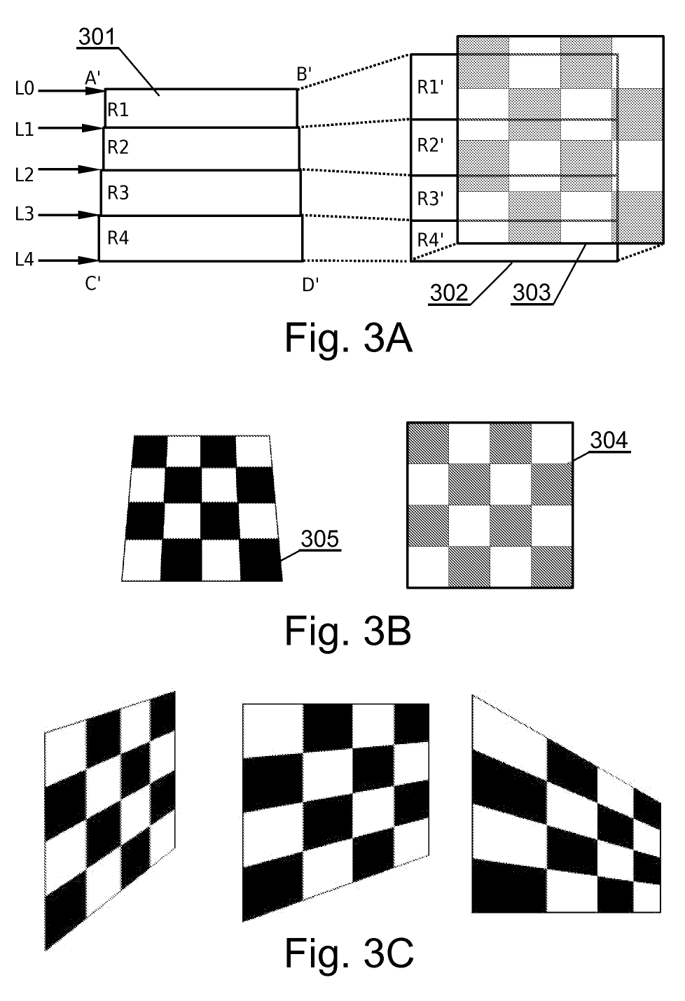

As shown in FIG. 3A the present method uses rectangles for image rendering. The four corners of the geometric shape 302 having an assigned texture 303, are now a rotated shape 202, as shown in FIG. 2B, and are perspective projected onto the 2D screen plane 301, as shown in FIG. 3A. The outline of the destination image will be split into a relatively small number of intermediate rectangles. Nevertheless the small number of the intermediate rectangles shall not be treated as limiting.

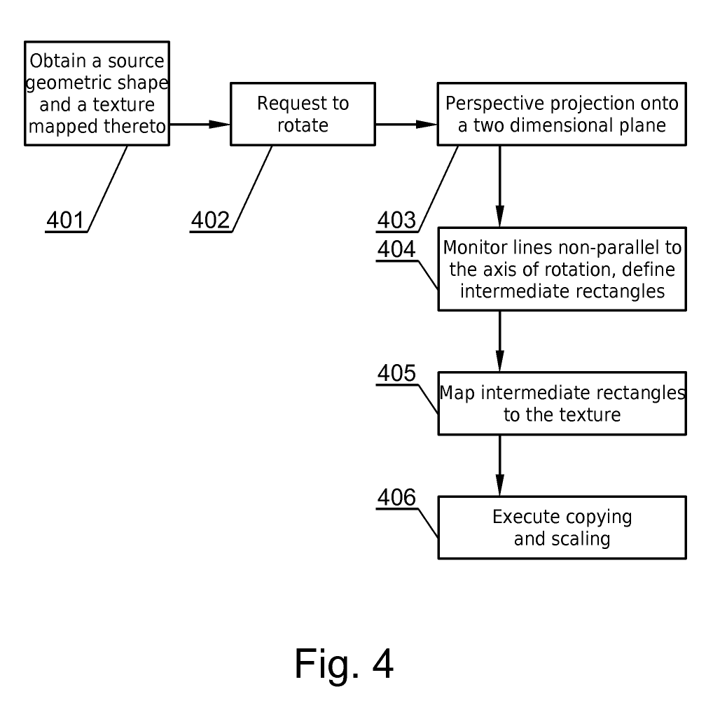

In this example four intermediate rectangles are defined R1-R4 that correspond to R1′-R4′ rectangles on the geometric shape 302, which represents geometric shape 201 in this exemplary rotation around Y axis. The assigned texture 303 shows how texture 208 is mapped to the geometric shape 302. Details of the procedure used to extract and process the rectangles have been shown with reference to FIG. 4.

It is to be understood that at least one of the intermediate rectangles may have four equal sides.

After copying rectangles R1′-R4′ with scaling so that they fit into intermediate rectangles R1-R4, the geometric shape with a mapped texture 304 of FIG. 3B will typically look as shown 305 in FIG. 3B. In this case more intermediate rectangles have been used.

One skilled in the art will easily recognize that as a result of perspective projection of a geometric shape, the method may obtain different shapes. The obtained shape depends on axis of rotation, angle of rotation and position of the geometric shape, relative to the observer, in the three-dimensional space. Examples of shapes obtained by rotation along the Y axis, with different positions in the three-dimensional space, are depicted in FIG. 3C.

The steps of the method according to the present technical concept have been shown with reference to the FIG. 4. The first step 401 is to obtain a source geometric shape and a texture mapped thereto. The next step 402 is to receive a request to rotate the source geometric shape of step 401.

The source geometric shape 101, 201 or 302 is defined in three-dimensional space by four points, each having corresponding X, Y and Z coordinate. When textures are used, each of the points A, B, C, D is also given a pair of (u, v) coordinates on the texture 107, 208 or 303. The texture is a rectangular image U pixels wide and V pixels high. The (u,v) coordinates define the portion of the texture that is to be mapped onto the rotated source geometric shape.

The next step 403, of the method, is to define a two dimensional outline of a rotated source geometric shape by performing a perspective projection onto a two dimensional plane. A perspective projection of the geometric shape from 3D space to 2D space is executed. Four corners of the rotated geometric shape are defined A′, B′, C′, D′ as shown in FIG. 3A.

In this step the system also calculates lines, non-parallel to the axis of rotation, between A′-C′ and B′-D′ as shown in the example in FIG. 3A, using for example the Bresenham algorithm. It is to be understood that other algorithms may be used for this task.

In step 404, lines, of the two-dimensional outline, non-parallel to the axis of rotation, are checked in terms of their angle and coordinates change. Division positions are set to create a set of intermediate rectangles on the target (rotated) geometric shape. The splitting points are set in places where pixels of either A′C′ or B′D′ line changes their X coordinate from x1 to x4 by a predetermined number of pixels, as shown in case of FIG. 3A. Generalizing, those division lines are given labels from L0 to Ln, wherein the value of “n” determines the number of intermediate rectangles. It should be noted, that lines from L0 to Ln are also called division lines for the sake of simplicity in describing the method.

The predetermined number of pixels may be kept low in order to achieve better quality. However the system may set division lines of the intermediate rectangles in places where monitored coordinate changes for example by several pixels. The intermediate rectangles will be larger and fewer copying and scaling operations will be required. Thus, at the cost of quality, performance is gained.

Next, in step 405 of the procedure, a mapping is made in order to find for each intermediate rectangle R1-Rn, of the two dimensional outline, a corresponding rectangle R1′-Rn′ on the texture 107, 208 or 303 respectively. In the presented examples n is equal to 4. This may be achieved by a texture mapping with a perspective correction as described in details with reference to the following steps.

The first step is to compute values of 1/z and v/z for points A and C. These are specified as parameters: A_{1/z}, C_{1/z}, A_{v/z}, C_{v/z} respectively. Next, for each Li division line (for i=0 to n), to linearly interpolate the 1/z parameter (specified as Li_{1/z}) and v/z parameter (specified as Li_{v/z}) along the AC edge. Li_{1/z} can be calculated based on linear interpolation:

Li_{1/z}/(C_{1/z}−A_{1/z})==(Liy−A′y)/(C′y−A′y)=>Li_{1/z}==((Liy−A′y)/(C′y−A′y))*(C_{1/z}−A_{1/z})

and Li_{v/z} can be calculated similarly:

Li_{v/z}/(C_{v/z}−A_{v/z})==(Liy−A′y)/(C′y−A′y)=>Li_{v/z}==((Liy−A′y)/(C′y−A′y))*(C_{v/z}−A_{v/z})

where Liy, A′y, C′y are y coordinates of A′, C′, Li points. Subsequently these computations are performed in order to get V value:

Z=1/Li_{1/z}

Liv=Li_{v/z}*Z

Now for Ri′ rectangle (for i=1 to n) the source coordinates for blit operation (copying with scaling) are defined as coordinates on texture:
top left corner: (Au, Li-1v)
bottom right corner: (Bu, Liv)
   where Au and Bu are “u” coordinates of A and B points. The target rectangle to blit to (to copy with scaling) is Ri′ rectangle itself in step 406. A specific hardware module, called a blitter, may be used to do this processing. Typically all target rectangles require scaling, it may however happen that only copying will suffice for some of them. For example copying may be enough for the target rectangle closest to the axis of rotation.

Each gain in performance of rotations and drawing of intersected geometric shapes has a significant impact on overall performance of the graphics systems. Such graphics system may be a two or three dimensional graphics generating and processing system. Recently such systems also include 2.5D graphics systems, where a computer system uses 2D computer graphics to visually simulate 3D computer graphics.

In a 2.5D graphics system, where there is no Z buffer, allowing for image depth management, each rectangle generated by the present method will be assigned a Z coordinate in order to distinguish, the layers generated, in the third dimension. It is however to be understood, that other geometric shapes than a rectangle may be used.

In order to make the rotation, the system receives a source geometric shape, for example a rectangle, and an angle of rotation as a parameter.

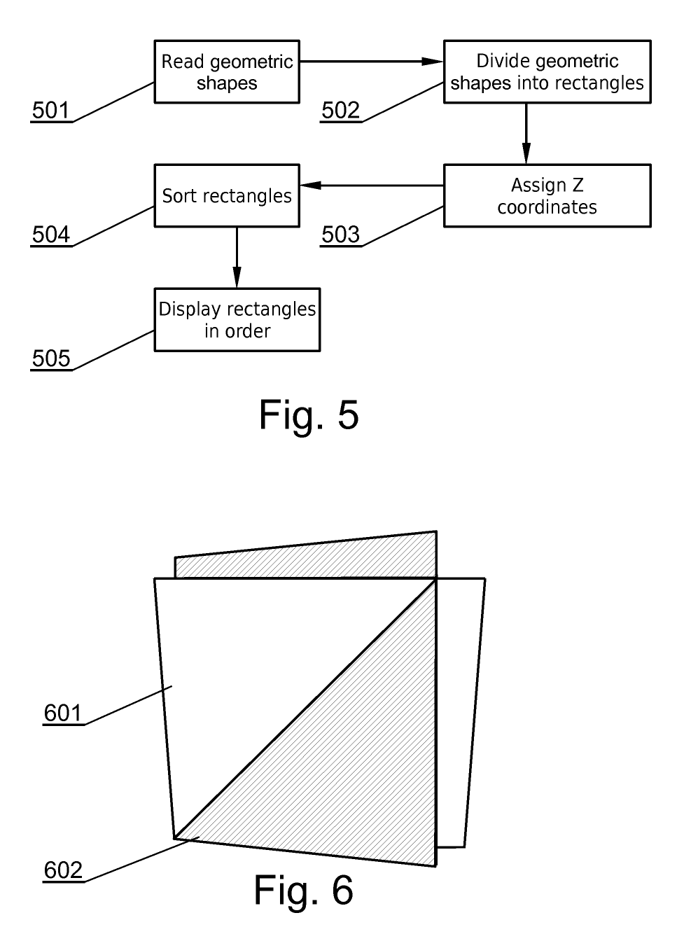

FIG. 5 is a block diagram presenting steps of generating intersected images. The procedure receives, in step 501 of the procedure, several geometric shapes to be displayed as intersected, when at least one of the geometric shapes has a specified rotation angle.

All geometric shapes are then divided, in step 502 of the method, into horizontal (in case of rotation along the “X” axis) or vertical (in case of rotation along the “Y” axis) rectangles, having a constant depth coordinate. This division may be calculated as presented with reference to FIG.1-FIG. 4.

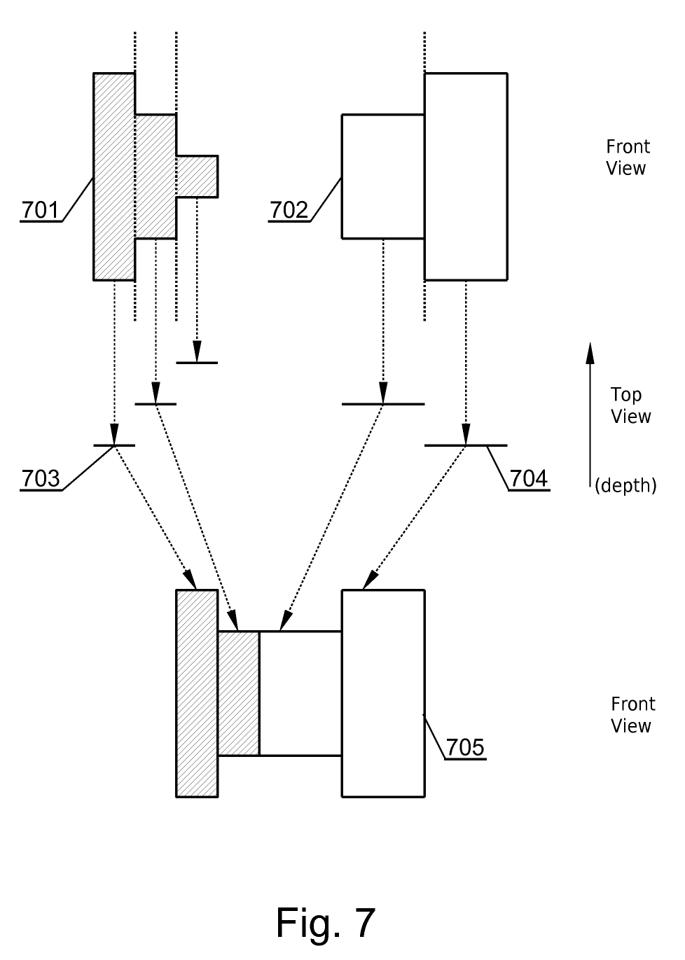

Each rectangle of the target image (textures can be used for geometric shapes) has X (width coordinate), Y (height coordinate) and Z (depth coordinate) values assigned in step 503 of the procedure (described later with reference to FIG. 7). All rectangles (both horizontal and vertical) coming from all geometric shapes are subsequently sorted, in step 504, for example using a queue, by the “Z” coordinate in such a way that the rectangles with the “Z” coordinate further from the observer are put to the beginning of the sorted queue and with “Z” coordinate closest to the observer are put to the end of the sorted queue. Next drawing of geometric shapes starts, in step 505, from the beginning of the sorted queue to the end of the sorted queue. If two or more rotated geometric shapes are intersecting each other, this will also be reflected in an output image.

FIG. 6 is an example of intersected images. In the presented case both images are slightly rotated. The hatched portion is a part of image 602 visible to the observer. The remaining part is obscured by a portion of the image 601.

FIG. 7 depicts an example of creation of intersected geometric shapes. In this example two geometric shapes 701 and 702 are defined. These geometric shapes have already been rotated, by an angle alfa and beta respectively, along the Y axis. Each geometric shape has an initial depth coordinate assigned and when rotated and prepared for splitting into rectangles, the depth coordinate of each rectangle has to be computed.

The depth coordinate of the leftmost rectangle of the geometric shape 701 and rightmost rectangle of the geometric shape 702 does not change after the rotation. Whereas the opposite coordinate changes according to equation:

z=−x*sin(angle)+z*cos(angle)

Having the depth coordinates of the left and rights edges Z(l) and Z(r) and X coordinates of the left and right edge of the geometric shape on the screen plane (i.e after the projection to 2D) defined as X(l) and X(r) the system can compute the remaining parameters.

iZl=1/Zl

iZr=1/Zr

idZ=(iZr−iZl)/(Xr−Xl)

iZ=iZl

For each rectangle:

iZ=iZ+n*idZ

Z=1/iZ

where n is the width of the rectangle and Z is the depth coordinate of the rectangle.

In case of the geometric shape 701 there are three rectangles 703 and in case of the geometric shape 702 there are two rectangles 704.

After the calculations, when looking at the top view, it is evident when the rotated geometric shapes 701 and 702 are to be drawn in a manner such that they intersect 705, the rectangle of the geometric shape 701, which has the greatest value of the depth coordinate, shall be covered by a part of the geometric shape 702 that is closer to the observer.

Performance tests have shown that the method, according to the present technical concept, results in improved performance when angles of rotation between 0 degrees and 45 degrees are concerned. Improvement in performance is very significant in the range of 0 degrees to 15 degrees and significant in the range between 15 and 30 degrees. Between 30 and 45 degrees improvement is noticeable. Therefore the lower the angle of rotation the greater gain in performance improvement. Similarly angles in the range between −45 degrees and 0 degrees may be considered in case of counter clockwise rotation.

The method, according to the present technical concept, gives the best results with geometric shapes such as squares and rectangles but can be applied to images of other shapes, for example a trapezoid or a triangle. These shapes can be polygons or surfaces.

The method described herein is particularly useful when a device, executing the rotation, is equipped with a hardware 2D accelerator capable of copying 2D surface with simultaneous scaling.

It can be easily recognised, by one skilled in the art, that the aforementioned method may be performed by one or more computer programs. Such computer programs are typically executed by utilizing the computing resources in a computing device such as aforementioned personal digital assistants, cellular telephones, receivers and decoders of digital television or the like. Applications are stored in non-volatile memory, for example flash memory or volatile memory, for example RAM and are executed by a processor. These memories are exemplary recording media for storing computer programs comprising computer-executable instructions performing all the steps of the computer-implemented method according the technical concept presented herein.

While the technical concept presented herein has been depicted, described, and has been defined with reference to particular preferred embodiments, such references and examples of implementation in the foregoing specification do not imply any limitation on the concept. It will, however, be evident that various modifications and changes may be made thereto without departing from the broader scope of the technical concept. The presented preferred embodiments are exemplary only, and are not exhaustive of the scope of the technical concept presented herein. Accordingly, the scope of protection is not limited to the preferred embodiments described in the specification, but is only limited by the claims that follow.

The invention claimed is:

1. A method for drawing geometric shapes, the method comprising the steps of
obtaining a request to draw at least two geometric shapes, each having assigned a depth coordinate and at least one having a depth coordinate variable across its surface as a result of a rotation about a rotation axis;
dividing the geometric shapes into rectangles having a depth coordinate of constant value;
sorting the rectangles according to the depth coordinate of constant value; and
drawing the rectangles in a sorted order to form an output image.

2. The method according to claim 1, wherein by the drawing the rectangles for each rectangle is found a corresponding part of a texture image taking perspective correction into account and copying, with scaling, the corresponding part of the texture image in order to fit it into a rectangle being drew.

3. The method according to claim 1 wherein the sorting the rectangles is performed by putting to a beginning of sorted queue the rectangles with the depth coordinate further from an observer.

4. The method according to claim 1, wherein the dividing the geometric shapes into rectangles comprises steps of
defining a two dimensional outline of a rotated source geometric shape by
performing its perspective projection onto a two dimensional plane; and
splitting the two dimensional outline, into intermediate rectangles, in places where pixel of either of the lines, non-parallel to the rotation axis, of the two dimensional outline changes coordinates wherein in case of a rotation around the Y-axis, pixel's Y-coordinate value changes by n counted from a Y-coordinate value of a previous split point or a start point of a line non-parallel to the rotation axis of the two dimensional outline and wherein in case of a rotation around the X-axis, pixel's X-coordinate value changes by n counted from an X-coordinate value of a previous split point or a start point of a line non-parallel to the rotation axis of the two dimensional outline.

5. The method according to claim 4 wherein the lines, non-parallel to the rotation axis, of the two dimensional outline are calculated using Bresenham algorithm.

6. The method according to claim 4 wherein the value of the n parameter is preferably 1 or −1.

7. The method according to claim 4 wherein at least one of the intermediate rectangles has four equal sides.

8. The method according to claim 4 wherein all depth coordinates of the Z axis of the source geometric shape have equal value.

9. A computer program comprising program code means for performing all the steps of a method of claim 1 when said program is run on a computer.

10. A computer readable medium having computer-executable instructions performing all the steps of the computer-implemented method according to claim 1.
